(19) United States
(12) Patent Application Publication
(10) Pub. No.: US 2004/0108384 A1
(43) Pub. Date: Jun. 10, 2004

(54) Image data transfer device and image data transfer and display method

(76) Inventors: John C. Wang, Taipei (TW); Yung-Chieh Lin, Taipei (TW); Szu-Wei Lin, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/397,733

(22) Filed: Mar. 26, 2003

(30) Foreign Application Priority Data
Dec. 6, 2002 (TW) 091135384

(51) Int. Cl. G06K 19/06

(52) U.S. Cl. 235/492

(57) ABSTRACT

An image data transfer device for use with a portable non-volatile memory card and an optical disc includes a memory card socket for attaching thereto the portable non-volatile memory card; a digital image processor electrically connected to the portable non-volatile memory card which has been attached to the memory card socket, reading a digital image data from the portable non-volatile memory card, and transforming the digital image data into an interactive image file; and a recording device electrically connected to the digital image processor for writing the interactive image file into the optical disc which has been placed into the recording device.

### FIELD OF INVENTION

The present invention relates to an image data transfer device, and more particularly to a device for transferring digital image data. The present invention also relates to a method for transferring digital image data.

### BACKGROUND OF INVENTION

Most of the still images generated from digital still cameras (DSCs) today are stored using a computer. FIG. 1 is a block diagram showing a DSC 11 connected to a personal computer 10 for the purpose of data transfer and display. Still images generated are first stored in a memory card 111 inside the DSC. Common memory card formats include the Compact Flash (CF) card, Smart Media (SM) card, Multi-Media Card (MMC), Memory Stick (MS), Secure Digital (SD) card, and the Microdrive. Images are read from the memory card 111 and transferred through a high-speed data interconnection 12 (e.g., USB or IEEE 1394) to the computer 10 for storage in hard disk 101. Software applications running on the computer 10 can be used to edit and view the still images.

For the regular user, the complex process of operating the computer for transferring still images can be a hassle. The goal of this invention is to provide a easy-to-use device for transferring still images for storage and viewing, thereby resolving the problems presented by current methods.

### SUMMARY OF INVENTION

An aspect of the present invention relates to an image data transfer device for use with a portable non-volatile memory card and an optical disc. The portable non-volatile memory card stores therein a digital image data. The image data transfer device comprises a memory card socket for attaching thereto the portable non-volatile memory card; a digital image processor electrically connected to the portable non-volatile memory card which has been attached to the memory card socket, reading the digital image data from the portable non-volatile memory card, and transforming the digital image data into an interactive image file; and a recording device electrically connected to the digital image processor for writing the interactive image file into the optical disc which has been placed into the recording device.

Preferably, the digital image data is a compressed data, and the digital image processor includes a decompressor that is electrically connected to the portable non-volatile memory card attached to the memory card socket for decompressing and then outputting the digital image data.

In an embodiment, the digital image processor further includes a scaler that is electrically connected to the portable non-volatile memory card attached to the memory card socket for scaling and then outputting the digital image data.

In an embodiment, the digital image processor further includes an image rotator that is electrically connected to the portable non-volatile memory card attached to the memory card socket for rotating and then outputting the digital image data.

In an embodiment, the digital image processor further includes an image effect processor that is electrically connected to the portable non-volatile memory card attached to the memory card socket for applying a certain image effect onto and then outputting the digital image data.

In an embodiment, the digital image processor further includes an alpha blender that is electrically connected to the portable non-volatile memory card attached to the memory card socket for alpha-blending and then outputting the digital image data.

Preferably, the digital image processor further includes a compressor that is electrically connected to the portable non-volatile memory card attached to the memory card socket for compressing the digital image data into the interactive image file, and then outputting the interactive image file.

In an embodiment, the recording device is CD writer, and the memory card socket, the digital image processor and the recording device are incorporated in a common housing.

Preferably, the interactive image file is revealed as an index frame consisting of a plurality of thumbnail photos.

Another aspect of the present invention relates to an image data transfer and display method for use with a portable non-volatile memory card and a display. The portable non-volatile memory card storing therein a digital image data. The image data transfer and display method comprises steps of transforming the digital image data into an interactive image file; writing the interactive image file into an image data storage medium; reading out the interactive image file from image data storage medium through an interactive operational interface; and revealing the interactive image file on the display in a certain mode.

Preferably, the step of transforming the digital image data comprises decompressing, scaling, rotating, image-effect-adjusting and/or alpha-blending the digital image data, and then compressing the digital image data into the interactive image file.

In an example, the image data storage medium is an optical disc, the interactive operational interface is an interactive intuitive interface operating on a digital video player, and the display is connected to the digital video player.

In another example, the image data storage medium is an optical disc, the interactive operational interface is an interactive interface operating on a computer system, and the display is a computer monitor.

In a further example, the image data storage medium is a hard disc, the interactive operational interface is an interactive interface operating on a computer system, and the display is a computer monitor.

Preferably, the interactive image file is revealed by an index frame including a plurality of thumbnail photos.

Alternatively, the index frame includes a plurality of rows and columns of thumbnail photos and an enlarged photo selected from the plurality of rows and columns of thumbnail photos.

### BRIEF DESCRIPTION OF THE DRAWINGS

The present invention may best be understood through the following description with reference to the accompanying drawings, in which:

FIG. 1 is a schematic block diagram showing the connection between a DSC with a personal computer for data transfer and display;

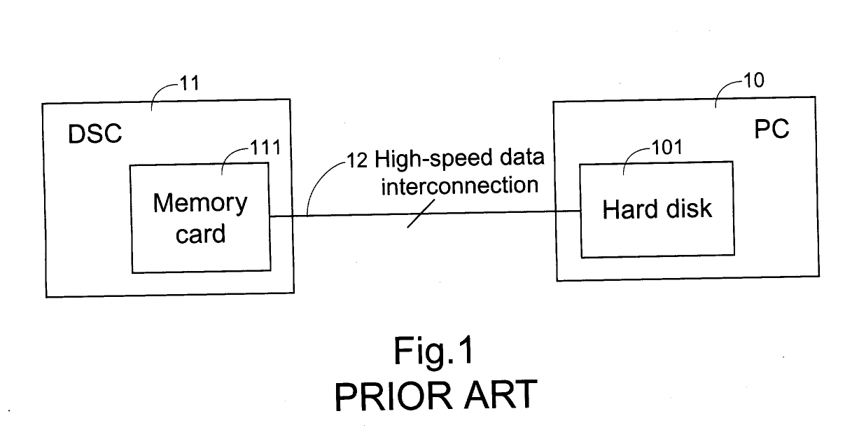

FIG. 2 is a schematic diagram showing an image data transfer device according to a preferred embodiment of the present invention;

FIG. 3 schematically exemplifies the configuration of an image data transfer device of the present invention;

FIG. 4 is a schematic block diagram showing a digital image processor included in the image data transfer device of FIG. 2;

FIG. 5 schematically illustrates a kind of frame shown on a display by using a data transfer and display method according to the present invention;

FIG. 6 schematically illustrates another kind of frame shown on a display by using a data transfer and display method according to the present invention; and

FIG. 7 schematically shows a computer system to which the present device is applied.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

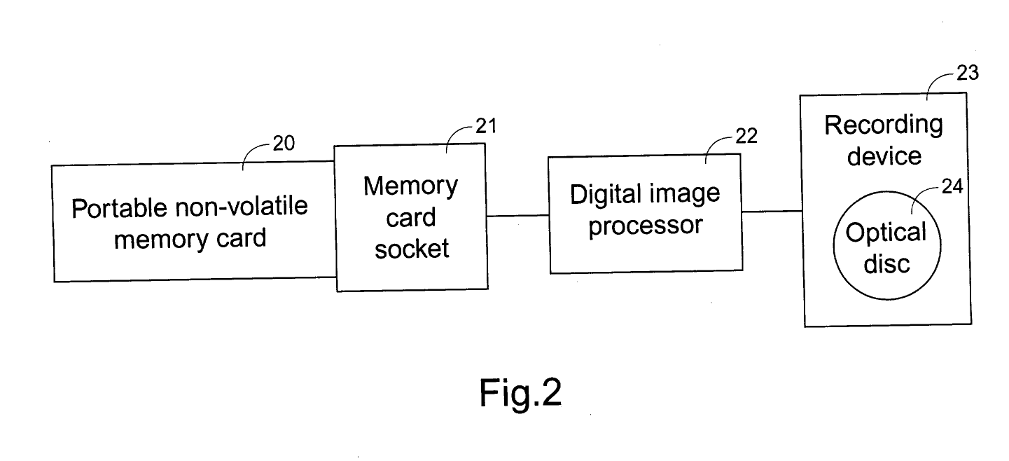

FIG. 2 shows a block diagram of a preferred embodiment of the image data transfer device according to the present invention. A memory card socket 21 allows for the insertion of a portable non-volatile memory card 20. Common memory card formats include the Compact Flash (CF) card, Smart Media (SM) card, Multi-Media Card (MMC), Memory Stick (MS), Secure Digital (SD) card, and the Microdrive. A digital image processor 22 is electrically connected through the socket 21 to the memory card 20 to read in still images stored in the memory card and convert them into a file or files of an interactive image format. The digital image processor 22 is also electronically connected to a recording device 23 (e.g., a CD writer) holding an optical disc 24 and writes the converted interactive image file or files into the disc.

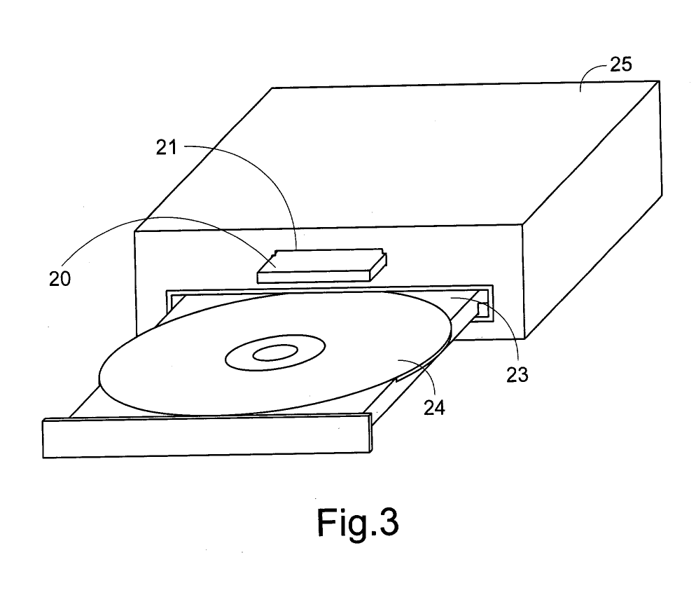

The components above can be placed in an enclosure 25 whose appearance resembles that depicted by FIG. 3. In this manner, the user can directly transfer digital images stored in the non-volatile memory card 20 using the device disclosed in this invention and store them into optical disc 24 to create a disc with interactive photo contents.

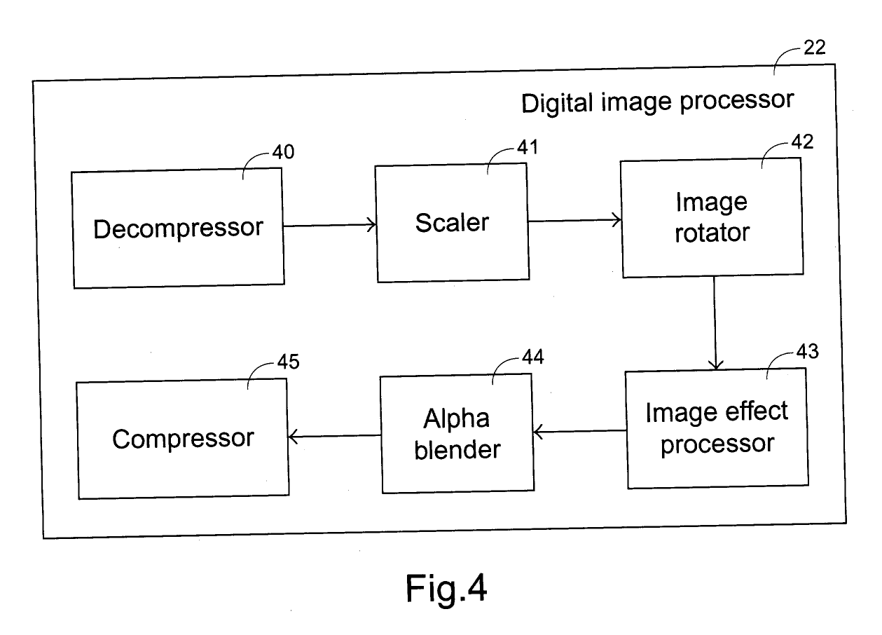

Furthermore, FIG. 4 shows the internal blocks of the preferred embodiment of the digital image processor 22. Since the images are usually stored in compressed formats on non-volatile memory cards, decompressor 40 is used to extract still images from their compressed formats. One common case has compressed JPEG files in the memory card 20 extracted as YCbCr (4:2:2) or YCbCr (4:1:1) format through the decompressor. Digital still images are often taken at mega-pixel resolutions and are too large for display on the television, a scaler 41 is designed to resize the decompressed images down to sizes suitable for display and for used as thumbnail indexes. One common algorithm used for scaling images is by averaging the color values of a block of pixels as a smaller block of pixels. Also sometimes still images are taken with the camera rotated 90 degrees to either side. An image rotator 42 is used to rotate the scaled images by for example 90, 180, or 270 degrees as its output.

In addition, in order to add enhancements and special effects to the generated images, an image effect processor 43 (e.g., an n-by-n convolution filter) can be used to compute against the pixels and generate effects including blurring, sharpening, edge-detection, etc. An alpha blender 44 takes a set of still images and compose them by creating semi-transparent overlapping effects among them. Lastly, a compressor 45 takes the output from the above mentioned devices, converts them into an interactive image file or files and writes them into an optical disc. A common interactive image format is the VCD or DVD format which contains compressed MPEG still images.

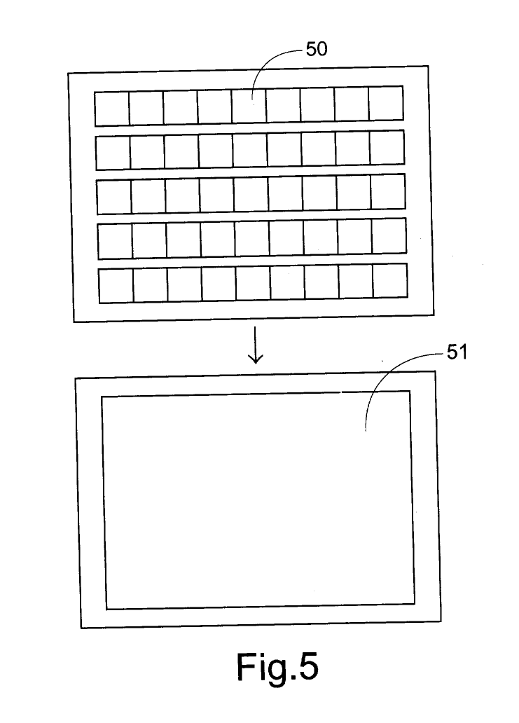

A disc containing images for interactive playback on DVD and VCD players is created from the above steps. A number of index pages like that shown in FIG. 5 is displayed during playback for easier retrieval of a specific image. The index page is composed of thumbnail images 50 generated through the scaler 41 and alpha blender 44. The user can easily select one of the thumbnail images 50 using the control device of the DVD or VCD player (e.g., the remote control) for full-screen display. For example, when the user presses “1” on the remote control, the corresponding image is displayed in full screen 51 and shown in full size on the TV. The screen-sized image is also generated by the scaler 41 before being recorded on the disc. If the image is rotated when the shot was taken, the user can use the remote control to rotate the image by pressing the appropriate button. The rotated views of a photo are generated through the image rotator 42 device.

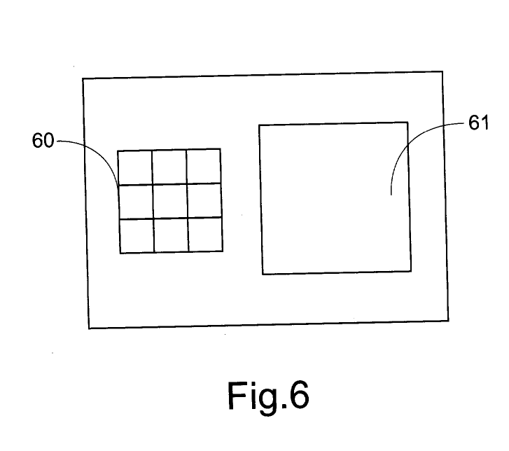

FIG. 6 is another form of index generated on the disc. Thumbnails are organized in 3-by-3 blocks 60. The design maps each thumbnail to one button on the numeric keypad commonly found on the DVD or VCD remote control so selecting an image for display is intuitive. The selected image can be shown in an enlarged view 61 or in a full-screen view 51.

In summary, this invention discloses a device that generates a disc containing digital images for playback on DVD and VCD players. The stored images are indexed through an intuitive interface so the user can enjoy digital photos without having to learn the complex operation of computers and special software applications. The device described above provides a convenient and intuitive way to solve traditional problems, thereby achieving the goal of the invention.

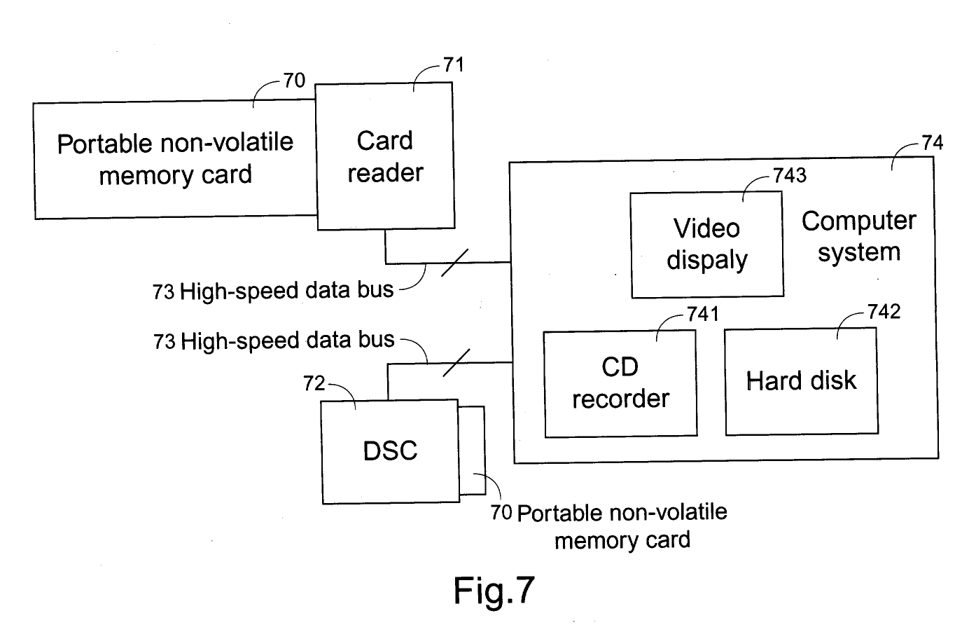

Also, some of the hardware blocks described above may be replaced by software to achieve the same purpose, as shown in FIG. 7. A memory card 70 installed in a card reader 71 or digital camera 72 is connected to a computer system 74 through a high-speed data bus 73. The computer system 74 includes a CD recorder 741, a hard disk 742 and a video display 743. The previously described process of transferring digital still images using the digital image processor 22 can be accomplished with software executed on the computer system 74. The generated interactive image data can be stored on an optical disc through CD recorder 741 or stored on the hard disk 742.

The process of transforming the image using software includes (a) decompression, (b) scaling, (c) image rotation, (d) image effect processing, (e) alpha blending, and (f) image compression. The final interactive image file or files is stored to an optical disc or a hard disk so the user can view the digital images through the computer monitor or the television. The principle and operations behind the software is similar to the above mentioned hardware and therefore the description is not repeated here.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image data transfer device for use with a portable non-volatile memory card and an optical disc, said portable non-volatile memory card storing therein a digital image data, said image data transfer device comprising:
a memory card socket for attaching thereto said portable non-volatile memory card;
a digital image processor electrically connected to said portable non-volatile memory card which has been attached to said memory card socket, reading said digital image data from said portable non-volatile memory card, and transforming said digital image data into an interactive image file; and
a recording device electrically connected to said digital image processor for writing said interactive image file into said optical disc which has been placed into said recording device.

2. The image data transfer device according to claim 1 wherein said digital image data is a compressed data.

3. The image data transfer device according to claim 2 wherein said digital image processor includes a decompressor that is electrically connected to said portable non-volatile memory card attached to said memory card socket for decompressing and then outputting said digital image data.

4. The image data transfer device according to claim 1 wherein said digital image processor includes a scaler that is electrically connected to said portable non-volatile memory card attached to said memory card socket for scaling and then outputting said digital image data.

5. The image data transfer device according to claim 1 wherein said digital image processor includes an image rotator that is electrically connected to said portable non-volatile memory card attached to said memory card socket for rotating and then outputting said digital image data.

6. The image data transfer device according to claim 1 wherein said digital image processor includes an image effect processor that is electrically connected to said portable non-volatile memory card attached to said memory card socket for applying a certain image effect onto and then outputting said digital image data.

7. The image data transfer device according to claim 1 wherein said digital image processor includes an alpha blender that is electrically connected to said portable non-volatile memory card attached to said memory card socket for alpha-blending and then outputting said digital image data.

8. The image data transfer device according to claim 1 wherein said digital image processor includes a compressor that is electrically connected to said portable non-volatile memory card attached to said memory card socket for compressing said digital image data into said interactive image file, and then outputting said interactive image file.

9. The image data transfer device according to claim 1 wherein said recording device is CD writer, and said memory card socket, said digital image processor and said recording device are incorporated in a common housing.

10. The image data transfer device according to claim 1 wherein said interactive image file is revealed as an index frame consisting of a plurality of thumbnail photos.

11. An image data transfer and display method for use with a portable non-volatile memory card and a display, said portable non-volatile memory card storing therein a digital image data, said image data transfer and display method comprising steps of:
transforming said digital image data into an interactive image file;
writing said interactive image file into an image data storage medium;
reading out said interactive image file from image data storage medium through an interactive operational interface; and
revealing said interactive image file on said display in a certain mode.

12. The method according to claim 11 wherein digital image data is a compressed data.

13. The method according to claim 12 wherein said step of transforming said digital image data comprises decompressing said digital image data.

14. The method according to claim 11 wherein said step of transforming said digital image data comprises scaling said digital image data.

15. The method according to claim 11 wherein said step of transforming said digital image data comprises rotating said digital image data.

16. The method according to claim 11 wherein said step of transforming said digital image data comprises applying a certain image effect onto said digital image data.

17. The method according to claim 11 wherein said step of transforming said digital image data comprises alpha-blending said digital image data.

18. The method according to claim 11 wherein said step of transforming said digital image data comprises compressing said digital image data into said interactive image file.

19. The method according claim 11 wherein said image data storage medium is an optical disc, said interactive operational interface is an interactive intuitive interface operating on a digital video player, and said display is connected to said digital video player.

20. The method according claim 11 wherein said image data storage medium is an optical disc, said interactive operational interface is an interactive interface operating on a computer system, and said display is a computer monitor.

21. The method according claim 11 wherein said image data storage medium is a hard disc, said interactive operational interface is an interactive interface operating on a computer system, and said display is a computer monitor.

22. The method according claim 11 wherein said interactive image file is revealed by an index frame including a plurality of thumbnail photos.

23. The method according to claim 22 wherein said index frame includes a plurality of rows and columns of thumbnail photos and an enlarged photo selected from said plurality of rows and columns of thumbnail photos.
